(19) United States
(12) Patent Application Publication
(10) Pub. No.: US 2007/0191071 A1
(43) Pub. Date: Aug. 16, 2007

(54) Method for isofrequency transmission of a digital signal with echo suppression and corresponding retransmission device

(75) Inventors: Eric Spampinato, Montgerval (FR); Olivier Rousset, Saint Aubin D' Aubigne (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Teamcast, Saint-Gregoire Cedex (FR)

(21) Appl. No.: 11/485,106

(22) Filed: Jul. 12, 2006

(30) Foreign Application Priority Data
Sep. 8, 2005 (FR) 05/09178
Jul. 13, 2005 (FR) 05/07565

(51) Int. Cl. H04B 1/38; H04M 1/00

(52) U.S. Cl. 455/570

(57) ABSTRACT

The disclosure relates to a method for isofrequency retransmission of at least one digital signal, including receiving said source signal on a receiving antenna; retransmitting said signal received to a transmitting antenna, a coupling occurring between said transmitting and receiving antennas; extracting at least one coupling echo from said signal received; processing of said coupling echo, so as to generate at least one correction signal; subtracting said correction signal from said source signal, generating an improved signal; and regenerating said improved signal by demodulation/remodulation, so as to retransmit said improved signal to said transmitting antenna.

### CROSS-REFERENCE TO RELATED APPLICATION

None.

### FIELD OF THE DISCLOSURE

The field of the disclosure is that of digital information broadcasting, such as terrestrial radio or television broadcasting, requiring the deployment of retransmission relays of which the role is to provide transmission coverage over an area initially not covered by the main transmitter.

A specific application of the disclosure is, in particular but not exclusively, Digital Terrestrial Television, which recommends digital processing by modulation/demodulation of signals at the level of the retransmission relays.

More specifically, the disclosure relates to the context in which the signal received by such a relay must be retransmitted without disturbance in the same frequency as the original source signal. It thus concerns an isofrequency retransmitter.

It is in particular the case of the Digital Terrestrial Television standard.

### BACKGROUND OF THE INVENTION

1. Digital Terrestrial Retransmission

In the context of terrestrial radio and television broadcasting, it is essential to provide continuous transmission coverage over an entire zone.

The geomorphology of the area to be covered causes the signals transmitted by the main transmitter to be subject to various disturbances and attenuations. Moreover, in urban areas, in particular, such radio or television broadcasting signals are subject to numerous reflections against buildings, the ground and other obstacles. These reflections therefore adversely affect the quality of the reception signal, causing selective attenuations, also called “fading”, and echoes, called “propagation channel-induced echoes”.

These causes of disturbances, which we will call transmission channel-induced disturbances, require the deployment of retransmission relays in order to provide widespread transmission coverage.

Such relays are conventionally called repeaters or “gap-fillers”. The primary function is to receive the signal coming from a main transmitter on a receiving antenna, then to retransmit this signal with a certain increase in power to the area to be covered by a transmitting antenna.

In the context of non-isofrequency retransmission, some relays include a digital processing unit, which demodulates, decodes and corrects the errors of the signal received, with the advantageous result of cleaning the source signal of disturbances due to the transmission channel described above, to which it may have been subjected during its incident propagation. These relays have a remodulation stage for retransmitting the incident signal to at a different transmission channel frequency.

Conventionally, such a processing unit can contain, in particular, reception algorithms making it possible to take into account the propagation echoes and the “fading” described above, due to the transmission channel, according to known techniques. This is true of the new digital standards such as DVB-T or DVB-H (“Digital Video Broadcasting—Terrestrial” or “Digital Video Broadcasting—Handheld”).

Other relays do not perform this digital processing operation called demodulation and remodulation. Some of them also operate in isofrequency retransmission.

In FIG. 1, such repeaters 11 consist primarily of a receiving antenna 110 in charge of sensing the signal transmitted 13 by the main transmitter 10, a unit 111 for processing this signal, an amplifier 112, and, finally, a transmitting antenna 113 in charge of retransmitting a signal 14, corresponding to the source signal that is amplified and purified of the imperfections caused by the transmission channel, over the entire coverage area 12.

However, the juxtaposition of a receiving antenna and a transmitting antenna on the same relay creates a detrimental, so-called “coupling” phenomenon. It is characterised by the fact that a portion of the signal retransmitted by the transmitting antenna returns to the receiving antenna and is detected by it. The term “Coupling echo” refers to this signal received at the receiving antenna, coming from the transmitting antenna. This “echo” terminology is explained by the fact that in the field of time analysis, the “parasite” signal detected by the receiving antenna corresponds to the original source signal, delayed by the transmission time Td.

The coupling echo significantly hinders the reception of the source signal to be retransmitted. It thus creates disturbances adding to the disturbances already described, associated with the transmission channel.

Indeed, this delayed signal that constitutes the coupling echo is amplified by the transmission chain of the repeater, which is obviously not desirable. Depending on the level of coupling obtained during the installation of the receiving antenna and the transmitting antenna, the system can break into oscillation, causing it to go into “protection” mode, which results in a reduction in the retransmission power due to a decrease in the transmission gain, even causing it to stop transmitting. This power reduction limits the transmission coverage and involves the establishment of additional relays.

2. Solutions of the Prior Art

Conventionally, to prevent the aforementioned problems of oscillation, as well as the problems of disturbance on the receiving antenna by the transmitting antenna (associated with the coupling), many repeaters function by receiving on a frequency channel and retransmitting in a different channel. Such a technique also enables the interference areas at the signal propagation level to be avoided. This technique makes it possible in particular to position two repeaters in neighbouring areas, on separate frequency bands, thus preventing any risk of disturbances by one repeater on the other, even though they cover a common area.

By way of example, the new technologies implemented in current digital repeaters are based on the power of the algorithms for receiving digital modulation standards such as DVB-T and DVB-H. They thus allow for a modern generation of repeaters based on the digital demodulation of the signal received, followed by a modulation, so as to finally retransmit in another channel. These digital repeaters with frequency change are sometimes referred to as retransmitters.

However, some applications may require retransmission at the same frequency (this involves an isofrequency transmitter).

The residual power of the transmitting antenna that returns to the receiving antenna then hinders the reception of the source signal to be retransmitted, since both signals are in the same frequency band: in this specific “isofrequency” configuration, the oscillation phenomenon described above may occur depending on the ratio of the signal received to the residual signal.

To overcome this phenomenon, there are already systems used today, called “anti-echo systems”.

Patent document EP 1 261 148 B1, incorporated here by reference, discloses a digital implementation, inspired by such an analogue anti-echo retransmission technique.

The general principle of such an anti-echo system is shown diagrammatically in FIG. 2.

The objective is to synthesise an Ecest signal, which corresponds to an adaptative estimation of the coupling echo Ec, in order to then subtract it from the incident signal R, consisting of the source signal to be retransmitted S and the coupling echo Ec.

It is also noted, in relation to FIG. 2, that such a device also includes a unit for transposition of the incoming radiofrequency signal to the process band (RF/IF), as well as units for analogue-to-digital conversion (ADC) and digital-to-analogue conversion (DAC), thus allowing for processing of the signals in the digital domain.

In other words, everything is based in this device on an overall adaptative estimation of the coupling echo.

3. Disadvantages of the Prior Art

All of the echo cancellation techniques of the prior art, designed and developed in order to deal with the oscillation problems mentioned above, have a number of disadvantages, as described below.

Indeed, these various anti-echo techniques, both in the digital and the analogue domains, have limited performances, depending on their implementation conditions, due to the fact that they implement adaptative algorithms.

Indeed, the adaptative filtering algorithms such as the LMS (“Least Mean Square”) on the overall estimation of an echo create problems well known to a person skilled in the art; they require compliance with strict convergence criteria, which are not easily achieved, or involve substantial calculation and storage resources.

In addition, in patent document EP 1 261 148 B1 mentioned above, the coupling echo is estimated directly and generally, which does not enable it to be effectively cancelled. Indeed, such an overall estimation of the coupling echo yields imprecise results, which can result in only a partial estimation of this echo.

One direct consequence of this disadvantage is that the coupling echo is then never entirely cancelled, and a detrimental residual echo disturbs and thus limits all of the processing operations performed, and travels from repeater to repeater.

Moreover, all of the systems described above are based on techniques derived from the analogue domain, dating back to a generation preceding the growing development of modem digital radio and television techniques. Such current anti-echo systems are therefore only an adaptation of the prior techniques. They do not take advantage of the technical advances of digital modulations and thus propagate transmission errors in addition to adding their own defects (phase noise of local oscillators, non-linearity distortions, linearity distortions, and so on) associated with analogue electronics.

More specifically, a disadvantage of the traditional “gap-filler” is to propagate the fading due to the first transmission channel.

Another disadvantage of the “gap-filler” of the prior art is that of the propagation of the signal degradation in the band: BER>0 and MER>30-32 dB (“Bit Error Rate” and “Modulation Error Ratio”).

The “gap-filler” of the prior art also has the disadvantage of adding the phase noise of the main transmitter to its own phase noise.

It is also noted that the “gap-filler” of the prior art propagates the echoes due to the transmission channel.

Finally, the inventors of the present disclosure have noted that the systems of the prior art have the disadvantage of having limited performance due to the fact that the level of the echo signal generated by the transmitting antenna must remain much lower than the source signal (normally lower than 5 dB). These systems do not therefore enable the coupling echo to be cancelled, insofar as its power is too high, which is problematic and limits the retransmission performance.

### SUMMARY

An embodiment of the invention is directed to a method for isofrequency retransmission of at least one digital signal including a step of receiving said signal on a receiving antenna and a step of retransmitting said signal received on a transmitting antenna, with a coupling occurring between said transmitting and receiving antennas.

According to an embodiment of the invention, such an isofrequency retransmission method also includes the following steps:
extraction of at least one coupling echo from said signal received;
processing of said coupling echo, so as to generate at least one correction signal;
subtraction of said correction signal from said signal received, generating an improved signal;
regeneration of said improved signal by demodulation/remodulation, so as to retransmit said regenerated improved signal on said transmitting antenna.

Thus, an embodiment of the invention is based on an entirely novel and inventive approach to the isofrequency transmission of a signal in the field of terrestrial radio or television broadcasting. Indeed, an embodiment of the invention proposes a new technique, intended to be implemented in digital signal repeaters, which combines the advantages of digital repeaters with frequency change and analogue isofrequency repeaters of the prior art.

More specifically, the technique of an embodiment of the invention proposes eliminating the detrimental coupling signal, by deriving, from the signal received, a correction signal, obtained from said coupling signal.

An embodiment of the invention is thus based on a cancellation of a coupling echo that will be generated during retransmission of the signal, and consists of a complete digital regeneration of the signal, after processing. It thus makes it possible to cancel, not only the coupling echoes appearing between the transmitting antenna and the receiving antenna, but also the echoes due to the propagation channel located upstream of the receiving antenna as well as the other imperfections, such as the phase noise and the “fading”.

This method is implemented in various retransmission products. It is known as a retransmitter with zero echo.

Said step of extracting said coupling echo advantageously implements a determination of at least one deformation parameter of said signal to be retransmitted on said transmitting antenna, due to said coupling.

In other words, the technique of an embodiment of the invention makes it possible to precisely and independently determine each deformation parameter of the coupling parameter, so as to obtain a very good estimation of the latter.

Said correction signal of an embodiment of the invention is obtained by adaptative deformation, taking into account said at least one deformation parameter, of said signal to be retransmitted on said transmitting antenna.

It is thus possible to obtain a correction signal very close to the real coupling echo, thereby enabling the latter to be completely cancelled.

According to an embodiment of the invention, said deformation parameter of the technique belongs to the group including:
a gain;
a delay;
a phase;
a group time.

Indeed, the coupling echo is characterised by a plurality of deformation parameters, with respect to the signal to be retransmitted, which are determined one-by-one: a gain, a delay, a phase and a group time.

In a specific embodiment of the invention, said adaptative deformation of said signal to be retransmitted includes the steps of:
applying a fixed delay corresponding to a duration of a sub-step of processing said signal of said regeneration step, to said signal to be retransmitted, generating a delayed signal;
adaptative filtering of said delayed signal, taking into account said gain and phase deformation parameters, so as to generate said correction signal.

In other words, the correction signal is obtained in two steps: by applying a delay to the signal to be retransmitted, and by the adaptative filtering of the delayed signal obtained. This breakdown of the correction signal determination into two steps allows for total cancellation of the coupling echo.

In the same specific embodiment of the invention, said adaptative deformation of said signal to be retransmitted also introduces a variable delay in said signal, and said adaptative filtering implements a complex multiplication for correction of said gain and phase deformation parameters.

More specifically, an additional delay is introduced, representing the delay due to the coupling of antennas, and a complex multiplication is used to correct the phase and the gain.

In a specific embodiment of the invention, said extraction of said at least one coupling echo implements at least one digital algorithm belonging to the group including:
a correlation algorithm;
an LMS-type error reduction algorithm.

Thus, advantageously, the adaptative filtering algorithms implemented in the adaptative deformation step of an embodiment of the invention are based on error reduction or correlation methods such as LMS (Least Mean Square).

The method of an embodiment of the invention advantageously also includes a step of amplification of said signal to be retransmitted.

Such a step makes it possible to compensate for any power losses in propagations of the signal to be retransmitted.

An embodiment of the invention also relates to a device for isofrequency retransmission of at least one digital signal including means for receiving a source signal on a receiving antenna, and means for retransmitting said source signal by a transmitting antenna, a coupling occurring between said transmitting and receiving antennas, so that at least one coupling echo transmitted by said transmitting antenna is received with said source signal on said receiving antenna. According to an embodiment of the invention, such a device includes:
means for extracting at least one coupling echo from said source signal
means for processing said at least one coupling echo, generating at least one correction signal;
means for subtracting said correction signal from said source signal, generating an improved signal;
means for regenerating said improved signal by demodulation/remodulation,
   so as to retransmit, on said transmitting antenna, said improved regenerated signal.

An embodiment of the invention also relates to a computer program downloadable from a communications network and/or stored on a support, in machine readable form and/or capable of being run by a microprocessor, including program code instructions for implementing the isofrequency retransmission method as described above.

Other characteristics and advantages of one or more embodiments of the invention will become clearer in the following description of a preferred embodiment, given by way of a simple illustrative and non-limiting example, and the appended drawings.

### BRIEF DESCRIPTION OF THE DRAWINGS

FIG. 1, already presented in relation to the prior art, shows a device for transmitting radio broadcasting information;

FIG. 2, also presented in relation to the prior art, diagrammatically shows an isofrequency repeater of the prior art;

FIG. 3 diagrammatically shows the synopsis of an embodiment of the invention;

FIGS. 4A and 4B show a retransmitter of an embodiment of the invention with an alternative to the return path, with respect to the retransmitter of FIG. 3;

FIG. 5 describes another alternative to the diagram of FIG. 3, which differs therefrom by virtue of the retransmitted signal correction mode;

FIGS. 6A and 6B describe other alternatives of a retransmitter in which the echo extraction is performed differently;

FIG. 7 shows a diagram of a specific embodiment of the invention;

FIGS. 8A and 8B are diagrams showing the carrier-to-noise C/N ratio under non-noise and noise conditions, respectively.

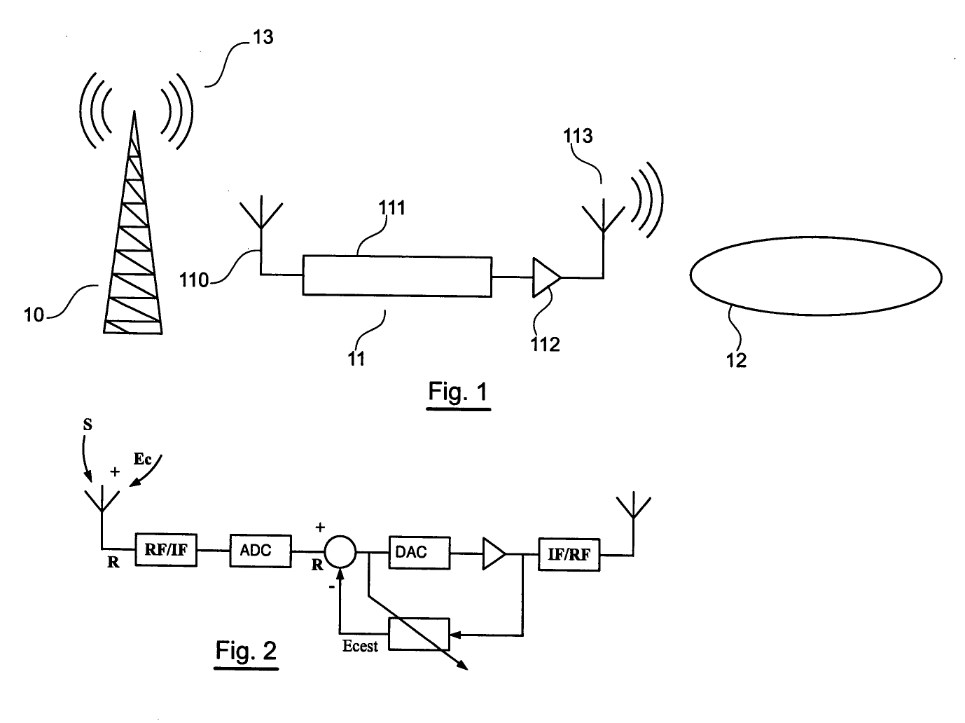

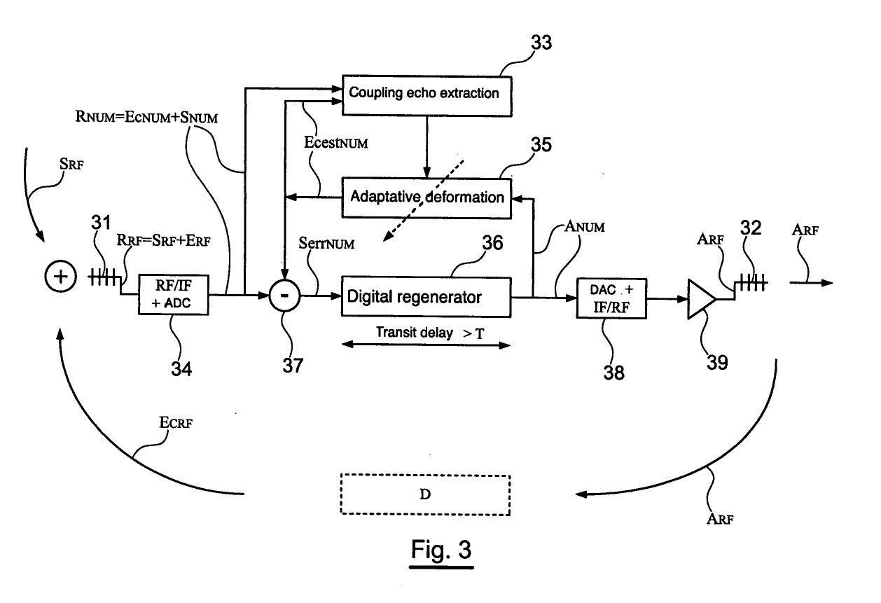

### DETAILED DESCRIPTION OF ILLUSTRATIVE EMBODIMENTS

1. General Principle

The general principle of an embodiment of the invention is based on the precise extraction of a coupling echo, at the level of the transmitting antenna of an isofrequency repeater, which makes it possible to generate a correction signal, which is subtracted from the signal received on the receiving antenna, so as to correct the deformations associated with the coupling that this signal will undergo after retransmission.

It is noted that in the technical field of radio or television broadcasting, the term “retransmission” is understood by a person skilled in the art to mean the process of demodulation of the source signal, followed by the remodulation process.

In addition, the modulation of a signal presents the specific characteristic of decorrelating this signal with itself when it is offset by a delay having a duration T.

The process for demodulation/remodulation of the signal received conventionally consists of processing it with sophisticated algorithms of which the role is to correct the source signal of the errors caused by the transmission channel, using digital correction methods in particular, then remodulating it so as to generate a “clean” signal that is reconstituted and not affected by errors. Such errors are due to the signal reflections, propagation interferences, the phase noise of the oscillators, and so on.

These operations are performed by a module called a digital regenerator.

In the context of an embodiment of the invention, a digital retransmitter receives, on its transmitting antenna, an incident signal that is broken down into two parts:
the source signal, which is to be modulated-demodulated with a digital regenerator as defined, so as to then be retransmitted;
a portion of the signal retransmitted by the transmitting antenna. This signal, which is in fact only an echo delayed by a time corresponding to the time for processing the entire chain, is deformed due to the coupling characteristics of the two transmitting and receiving antennas. Such a signal is called a coupling echo. Its power is generally lower than that of the source signal.

The general principle of the isofrequency retransmitter is then to eliminate the coupling echo by subtracting a so-called correction signal from the source signal.

According to an embodiment of the invention, this correction signal, which corresponds to an estimation of the coupling echo, is synthesized from a careful and precise determination of the deformation parameters of the signal to be retransmitted. These parameters, which we will hereinafter refer to as deformation parameters, can be: a gain, a delay, a phase, a group time, and so on.

The correction signal is therefore obtained by “deforming” the signal to be retransmitted by the application of estimated deformation parameters, which correspond to the characteristics of the coupling of antennas.

FIG. 3 shows all of the signals involved and the processing entities in a digital isofrequency retransmitter according to the general principle of an embodiment of the invention.

The receiving antenna 31 receives a source signal S_{RF} transmitted by a main transmitter, or by a previous retransmitter in the case of a cascade configuration. To this signal S_{RF}, a signal Ec_{RF} is added, which is the coupling echo, and corresponds to a portion of the signal A_{RF} to be retransmitted by the antenna 32. The signal A_{RF} is the conversion into an analogue signal (D/A) and radiofrequency (IF/RF) of the digital signal A_{NUM} to be retransmitted by the block 38.

The sum of the signals Ec_{RF} and S_{RF} forms a total analogue incident radiofrequency signal R_{RF}=Ec_{RF}+S_{RF} on the receiving antenna 31, which is then transposed in an intermediate frequency band IF and digitised (ADC) by a module 34. The result at the output of the module 34 is a digital signal R_{NUM}=Ec_{NUM}+S_{NUM}. Ec_{NUM} and S_{NUM} correspond respectively to the digitised coupling echo Ec_{RF} and the digitised source signal S_{RF}.

It is noted that the signal Ec_{RF} is substantially the same as the signal to be retransmitted A_{RF}, although it has undergone deformations due to the coupling of the antenna, which deformations are symbolised by a block D, including the real deformation parameters generally unknown, such as the delay, the gain (or the attenuation), the phase and the group time.

The main objective achieved by an embodiment of the invention is therefore a precise determination of these deformation parameters.

The receiver of an embodiment of the invention therefore includes a module 33, which we will hereinafter refer to as the coupling echo extraction module, which searches for the aforementioned deformations, from digital algorithms such as the correlation or reduction of the LMS (Least Mean Square) error. It is noted that these adaptative algorithms act directly and independently on specific parameters, and not on an error signal in its entirety, as is typically the case in the techniques of the prior art.

Once determined, the deformation parameters are integrated into an adaptative deformation module 35, of which the role is to apply the deformation parameters to the signal A_{NUM} to be retransmitted (therefore, not deformed by the coupling), so as to resynthesise the coupling echo Ec_{NUM}.

This adaptative deformation module 35 receives, at the input, the digital signal A_{NUM} to be retransmitted, and generates, at the output, the digital correction signal Ecest_{NUM}.

In other words, the module 35 adaptatively “deforms” the signal to be retransmitted A_{NUM} in order to reliably reconstruct the digital coupling echo Ec_{NUM}.

More specifically, the adaptative deformation is performed in two steps.

It is first constituted by a fixed delay, which is digitally produced by a memory. This delay corresponds to the time for processing the input and output stages of the modules 34 and 38.

The deformation to be made then to the signal A_{NUM} to be retransmitted corresponds to the coupling characteristics themselves: delay (of coupling between the two antennas), phase and gain. It is, for example, performed by an adaptative filter.

The signal Ecest_{NUM} obtained is a correction signal, which is subtracted 37 from the signal R_{NUM} received, a digital signal containing the source signal S_{NUM} and the coupling echo Ec_{NUM}.

The signal obtained Serr_{NUM} corresponds to the signal received R_{NUM}, from which the correction signal is subtracted: Serr_{NUM}=R_{NUM}−Ecest_{NUM}.

It is reinjected into the digital regeneration module 36.

It is noted that in the configuration of FIG. 3, the coupling echo extraction module 33 recovers the signal R_{NUM} received by the receiving antenna 31, which was previously transposed into a baseband (RF/IF) and digitised (ADC) by a unit 34. Indeed, in this specific configuration, the algorithms implemented for the extraction of the coupling echo require, at the input, the signal R_{NUM} received as well as the estimated signal Ecest_{NUM} of the coupling echo, which will enable the algorithms to quickly be adjusted in order to estimate the deformation parameters.

Various alternative embodiments of the invention can also be envisaged.

2. Alternatives for the Input of the Adaptative Deformation Module

In relation to FIG. 3 described above, it was noted that the input signal A_{NUM} of the adaptative deformation module is the digitised signal to be retransmitted. It is injected into the adaptative deformation module 35 before being converted into an analogue (DAC) radiofrequency (IF/RF) signal A_{RF} by the unit 38.

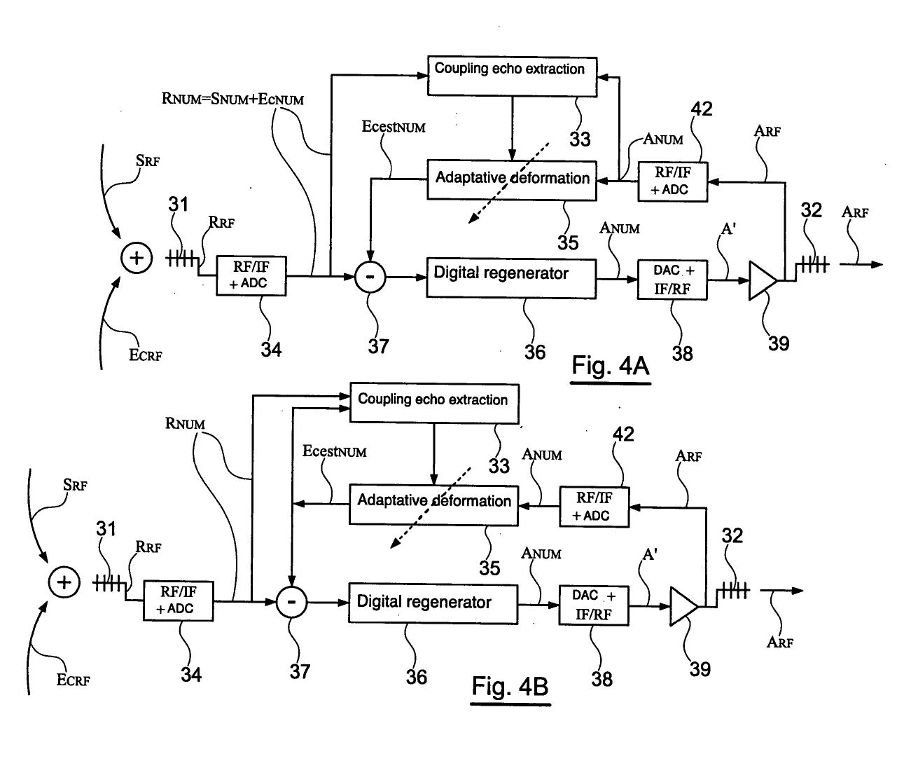

A first alternative (FIGS. 4A and 4B) consists of injecting, into the adaptative deformation module 35, the signal A_{RF} to be retransmitted, only after the steps of conversion of 38 this signal A_{NUM} into an analogue signal A′ and its transposition 38 into radiofrequencies, and after a step of amplification by the amplifier 39 of the signal A′ to be retransmitted, thus creating the signal A_{RF}.

Therefore, the correction signal Ecest_{NUM} to be extracted is closer to the coupling echo Ec_{NUM} because it takes into account the radiofrequency (RF) chain 34 and 38, as well as the characteristics of the amplifier 39.

Because the algorithms implemented in the adaptative deformation module 35 process exclusively digital signals, it is noted that this solution additionally requires a change 42 from a radiofrequency band into an intermediate frequency band (RF/IF) and a digital-to-analogue conversion 42, of high-quality.

It is noted that the devices of FIGS. 4A and 4B are differentiated by the input signals of the coupling echo extraction module 33. The device of FIG. 4A processes the digitised signal R_{NUM} received as well as the digitised signal A_{NUM} to be retransmitted. This enables the algorithms implemented by the module 33 to perform well, entailing the consequential resources, in terms of computing power.

In FIG. 4B, an alternative enables the module 33 to process the digitised signal R_{NUM} received as well as the correction signal Ecest_{NUM}. Such a technique then requires fewer resources in terms of computing power. In other words, the algorithm implemented in the device of FIG. 4B requires fewer resources, at the cost of inferior performance.

3. Alternative for the Extraction of the Correction Signal

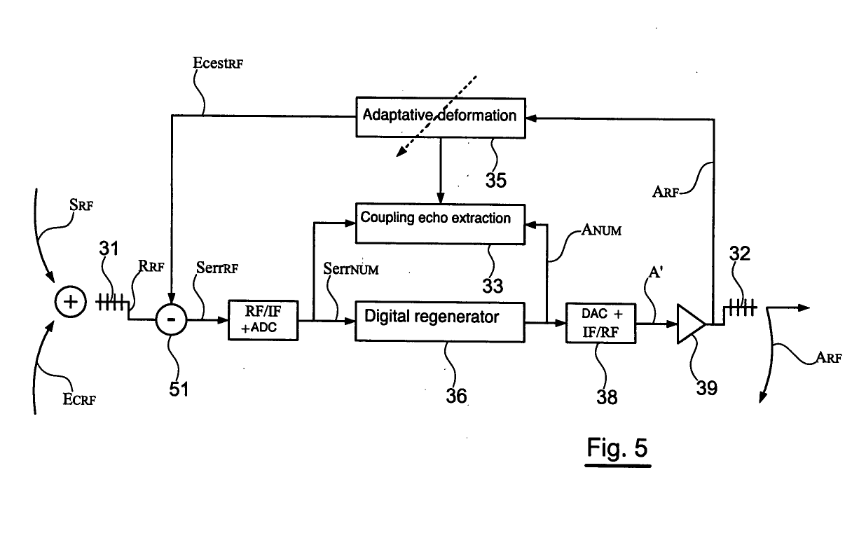

It is possible to consider an alternative (FIG. 5), in which the additional RF/IF change 42 and analogue-to-digital conversion ADC 42 mentioned above in relation to FIGS. 4A and 4B are no longer necessary.

For this, the adaptative deformation 35 of the signal A_{RF} to be retransmitted is performed entirely in the analogue domain and in radiofrequency (RF). The adaptative deformation module 35 then receives, at the input, the signal A_{RF} that corresponds to the signal to be retransmitted, which is analogue and in the radiofrequency band (RF). It generates, at the output, a correction signal Ecest_{RF} that is also analogue and in the radiofrequency band (RF), which is then extracted 51 from the incident signal R_{RF} directly at the level of the receiving antenna 31, in the analogue and radiofrequency domain (RF).

The radiofrequency signal Serr_{RF} is thus obtained, which is equivalent to:
Serr_{RF}=R_{RF}−Ecest_{RF}

Therefore, this is more realistic with respect to a digital baseband variation.

4. Alternatives for the Echo Extraction

It is noted that, according to an embodiment of the invention, the determination of deformation parameters, in the coupling extraction module 33, is based on adaptative algorithms. In the implementation of FIG. 3, these processing algorithms need, at the input, the signal R_{NUM} received, including the source signal S_{NUM} and the coupling echo Ec_{NUM}, as well as the correction signal Ecest_{NUM} corresponding to the deformed signal A_{NUM} to be retransmitted.

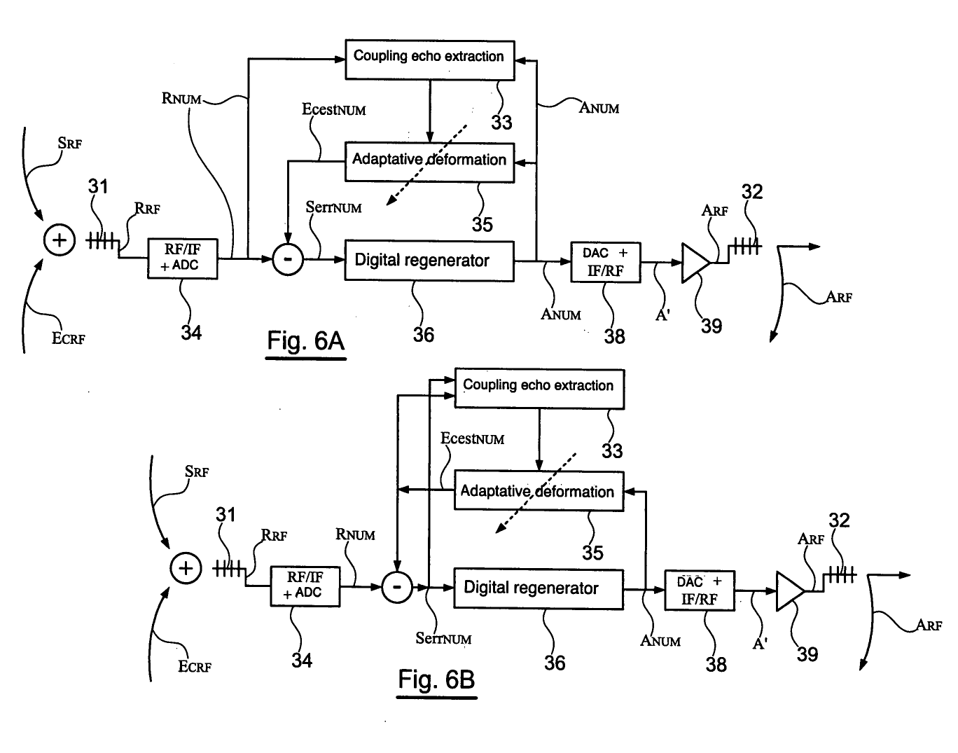

However, it is possible to implement other alternatives (FIGS. 6A and 6B) in these algorithms, which work by taking the comparison signals to other locations in the processing chain of the repeater.

In FIG. 6A, le correction signal Ecest_{NUM} at the input of the echo extraction coupling module 33 can be replaced by the signal A_{NUM} to be digitally retransmitted.

Lastly, in FIG. 6B, certain adaptative algorithms can process comparison signals at the input, including the correction signal Ecest_{NUM} and the signal Serr_{NUM} to be retransmitted, before the latter is processed by the digital egenerator 36 to obtain the actual digital signal A_{NUM} to be retransmitted.

5. Description of a Specific Implementation

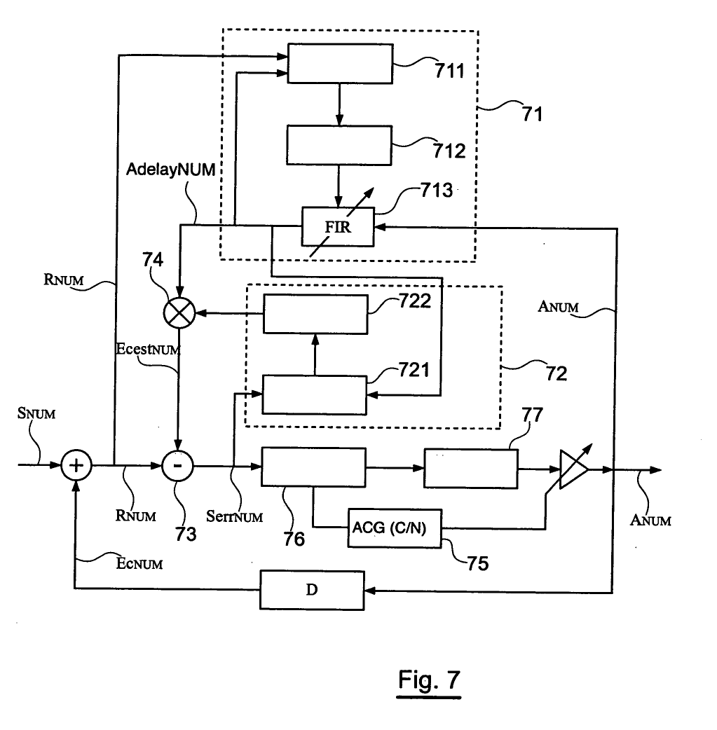

In relation to FIG. 7, the detail of the algorithms implemented in the method of an embodiment of the invention will now be described.

The “zero echo” method of an embodiment of the invention can be applied to digital signals, which are demodulated, then remodulated by a module already described above, called a digital regenerator.

An embodiment of the invention corrects the effects of the coupling between the receiving and transmitting antennas by processing the signal so as to extract the coupling therefrom.

It is also noted that the coupling is characterised by a delay, an attenuation and a phase shift between the signal received on the receiving antenna of the retransmitter and the signal retransmitted by the transmission antenna. Once the coupling has been identified, it is removed from the input signal.

For greater clarity, the various signals involved are annotated similarly to those of the previous FIGS. 3 to 6.

In addition, the algorithmic processing operations detailed in this part are performed on radiofrequency signals already translated into an intermediate frequency band and digitised. Therefore, FIG. 7 does not show the radiofrequency transformation units (RF/IF) or those of the analogue-to-digital (ADC) or reverse (DAC) conversions.

In relation to FIG. 7, the signals involved can be expressed mathematically:
R_{NUM}(t)=S_{NUM}(t)+K×A_{NUM}(t−τ)=S_{NUM}(t)+Ec_{NUM};
Serr_{NUM}(t)=R_{NUM}(t)−Ecest_{NUM}(t);
Y2(t)=K′×Adelay_{NUM}(t);
Adelay_{NUM}(t)=A_{NUM}(t−τ′);
Serr_{NUM}(t)=S_{NUM}(t)+K×A_{NUM}(t−τ)−K′×A_{NUM}(t−τ′).
With:
K=k e^{j*σ};
K′=k′e^{j*σ};
τ: Delay of the coupling of antennas and the entire analogue transposition chain;
k: Antenna coupling gain;
σ: Phase shift of the signal caused by the antenna coupling and the analogue transposition chain;
τ′: Estimation of the delay;
k′: Estimation of the coupling gain;
σ′: Estimation of the coupling phase shift.
The algorithm is then implemented in two steps.

In a first step, it is desirable to synchronise the input signal R_{NUM}, received by means of the receiving antenna and the output signal A_{NUM} retransmitted by the transmitting antenna, so as to cancel the delay between them. This operation is performed by the delay processing module 71.

Once the delay is zero or almost zero, the phase and gain processing unit 72 will activate the algorithm enabling the attenuation and the phase shift of the coupling to be estimated, so as to create a correction signal Ecest_{NUM}, and to remove 73 the latter from the input signal R_{NUM}.

In the fields to which an embodiment of the invention is applied, the coupling characteristics are fixed or vary very slowly over time, which therefore allows for the chaining of the two controls described.

The two steps performed successively by the delay processing module 71 and the phase and gain processing module 72 will now be described in detail.

5.1. Algorithm 1: Correction of the Delay

The measurement of the delay is performed between the signal R_{NUM} received at the receiving antenna and then digitised, and the digitised delayed output signal A_{NUM}, called Adelay_{NUM}. To perform this measurement, a correlation product 711 is performed between these two signals. The position of the correlation peak makes it possible to determine the delay between the signal Adelay_{NUM} and the coupling echo Ec_{NUM}=K×A_{NUM} (t-τ):
Error(τ′)=Max(Corrₙ(R_{NUM}(t), Adelay_{NUM}(t−n))).
With: Adelay_{NUM}(t)=A_{NUM}(t−τ′).
R_{NUM}(t)=S_{NUM}(t)+K×A_{NUM}(t−τ).
wherein n varies by +/−10 μs.
Corrₙ: correlation function.

The whole part of the delay is determined by the unit 712 owing to a delay line. The fractional part is determined by a Lagrange polynomial interpolator finite impulse response filter (FIR) 713 of order 1. The measurement and the correction of the delay are performed in an adaptative manner. The objective of the algorithm is to bring the Error(τ′) to 0.
τ′(n)=τ′(n−1)−G1×Error(τ′)(n)
With:
G1: adaptation algorithm gain
Error(τ′): Delay error estimated by the correlation between Adelay_{NUM} and K×A_{NUM}(t−τ).

The measurements performed show that the estimation of the Error(τ′) is reliable even with a signal (S_{NUM})_{dB}>(A_{NUM})_{dB}−30 dB

5.2 Algorithm 2: Correction of the Amplitude and Phase

The measurement and the correction of the amplitude and the phase begin when the delay becomes zero or almost zero, i.e. when the adaptation value of the delay becomes stable.

The measurement 722 is performed between the delayed output signal Adelay_{NUM} and the corrected input signal Serr_{NUM}. A correlation product 721 is performed between these two signals divided by the Adelay_{NUM} autocorrelation.

The source signal S_{NUM} received as well as the signal A_{NUM} retransmitted are expressed in vector form:
S_{NUM}=[C₁e^{jD1}, C₂e^{jD2}, . . . , Cₙe^{jDn}];
A_{NUM}=[A₁e^{jB1}, A₂e^{jB2}, . . . , Aₙe^{iBn}];
n is the size of the correlation window.

The coupling K of the antenna is expressed by showing the coupling gain and phase:

K=k e^{jb};

As a result:
Serr_{NUM}(t)=S_{NUM}(t)+K×A_{NUM}(t−τ)−K′×Adelay_{NUM}=S_{NUM}(t)+K×A_{NUM}(t−τ)−K′×A_{NUM}(t−τ′).
If τ=τ′, then:
Serr_{NUM}=S_{NUM}+(K−K′)×Adelay_{NUM},
Serr_{NUM}=[C₁e^{jD1}, (K−K′)A₁e^{jB1}, C₂e^{jD2}+(K−K′)A₂e^{jB2}, . . . , . . . , Cₙe^{jDn}]+(K−K′)Aₙe^{jBn}]
Autocorrelation:
   AutoCorr(Adelay_{NUM})=Σ_{(i=1án)}A₁², (1)
   Correlation:
   Corr(Serr_{NUM}, Adelay_{NUM})=Serr_{NUM}×Adelay_{NUM}^{T}
   Corr(Serr_{NUM}, Adelay_{NUM})=(K−K′)×(Σ_{(1án)}Aᵢ²)+S_{NUM}×Adelay_{NUM}^{T}

However, S_{NUM}×Adelay_{NUM}=0 because the modulated signals are processed (for example by OFDM: “Orthogonal Frequency Division Multiplexing”), and it is known that such a signal has the characteristic of being decorrelated with itself offset in time.
R_{NUM}A_{NUM}corr=(K−K′)×(Σ_{(i=án)}A₁²) (2)
Result:
   R_{NUM}S_{NUM}corr/S_{NUM}autocorr=(K−K′)×(Σ_{(i=1án)}A₁²)/(Σ_{(i=1án)}A₁²)
   R_{NUM}S_{NUM}corr/S_{NUM}autocorr=(K−K′)=Error(K′)

The correction of the signal A_{NUM} by the amplitude and the phase is carried out by a complex multiplication 74 of Adelay_{NUM} with K′. K′ is obtained by a simple control algorithm intended to bring Error(K′) to 0.
K′(n)=K′(n−1)−G2×Error(K′)(n)
With: G2: adaptation algorithm gain

Finally, the signal Serr_{NUM} is then reinjected into the demodulator 76, in order to then be remodulated by the modulator 77.

5.3 Performance:

For a DVB-T signal, the demodulation performance is very closely related to the carrier-to-noise ratio C/N of the signal received.

According to the prior art of receivers, a maximum Gaussian white noise is needed in order to have a reception providing an acceptable quality of service in the broadcasting world.

The table below provides an indication of the maximum carrier-to-noise ratio C/N for the most commonly used DVB-T modes so as to obtain less than one error every hour.

| Modulation | Rate of protection | C/N (Gaussian channel) |
|---|---|---|
| QPSK | — | 5 dB |
| QPSK | ⅔ | 7 dB |
| 16 QAM | — | 10 dB |
| 16 QAM | ⅔ | 13 dB |
| 64 QAM | — | 16 dB |
| 64 QAM | ⅔ | 18 dB |
| 64 QAM | ¾ | 20 dB |

In order for the system to function in the most commonly used modes, it is necessary to be capable of reducing the antenna coupling in order to have a maximum carrier-to-noise ratio C/N of 20 dB.

The first tests have shown that it is possible to obtain a carrier-to-noise ratio C/N greater than 25 dB up to a coupling of 0 dB (i.e. a feedback signal having the same power as the incident signal). However, this is valid only if the coupling changes only very slowly.

The table below gives an idea of the effect of an estimation error of the coupling on the carrier-to-noise ratio C/N of the Signal Serr_{NUM}, which directly attacks the demodulator.

| | | | Error on τ′ |
|---|---|---|---|
| C/N | Error on k′ (dB) | Error on σ′ (°) | (ns) |
| >10 dB | ±7.0 | ±67 | ±200 |
| >15 dB | ±3.3 | ±34 | ±120 |
| >20 dB | ±1.7 | ±21 | ±70 |
| >25 dB | ±0.9 | ±11 | ±20 |
| >30 dB | ±0.5 | ±6 | |

5.4 Initial Operating Conditions:

To return to the “detection” range of the echo suppression algorithms, an algorithm is set in the initial sensing condition.

At the time t0 when the signal has not yet been established, it is necessary to put A_{NUM}(t−T) at a level so that the power of the return signal is lower than the minimum carrier-to-noise ratio C/N that the chosen modulation mode requires. The principle consists of reducing the power of the repeater, then progressively increasing the power while acting on the echo suppression algorithm parameters. This level is adjusted by the use of a unit 75 for automatic gain control ACG controlled by the extraction of the value of the carrier-to-noise ratio C/N of the signal in the selected mode.

5.5 Simulation Results

The simulations performed make it possible to verify the convergence and the stability of the algorithms in theory and in the presence of a Gaussian white noise signal.

It is noted that N is in this case the power of the echo signal Ec considered to be the noise with regard to the carrier signal C.

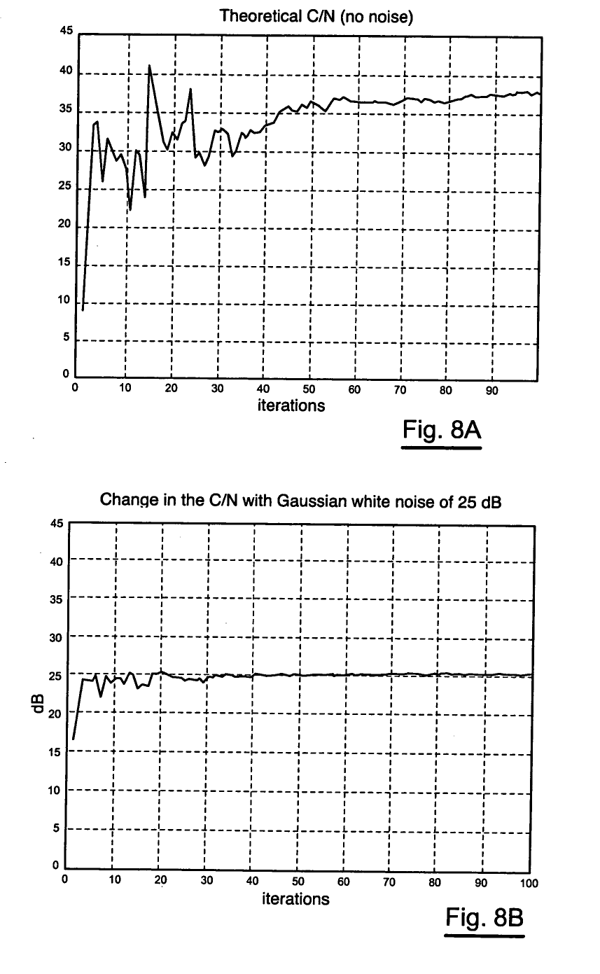

The graph of FIG. 8A shows the change in the theoretical carrier-to-noise ratio C/N, without noise, as a function of iterations, wherein an iteration equals a system cycle, with a phase shift in the coupling loop of 100° and an attenuation of 0 dB. In other words, the initial power of the coupling echo Ec is equal to that of the signal A to be retransmitted.

The parameters of the signals are: 64 QAM 1/16.

The graph of FIG. 8B shows the change in the theoretical carrier-to-noise ratio C/N, with a noise of 25 dB, as a function of iterations, wherein an iteration equals a system cycle, with a phase shift in the coupling loop of 100° and an attenuation of 0 dB. In other words, the initial power of the coupling echo Ec is equal to that of the signal A to be retransmitted.

The parameters of the signals are: 64 QAM 1/16.

The simulations show that after only 50 iterations, the system converges on objective performances greater than 20 dB, and ideally 25 dB, corresponding to the power of the Gaussian white noise of the channel.

6. Conclusion

One or more embodiments of the invention aim in particular to overcome one or more disadvantages of the prior art.

In particular, an embodiment of the invention proposes a technique for isofrequency retransmission of signals, which makes it possible to provide better conditions for television or radio broadcasting signal retransmission performance, and to increase the coverage zone, with respect to the techniques implemented in the repeaters of the prior art.

More specifically, an embodiment of the invention provides such a retransmission technique that is effective and high-performing, that provides all of the advantages of a digital repeater with frequency change of the isofrequency repeaters of the prior art.

Thus, an embodiment of the invention totally suppresses the fading described above, due to the first transmission channel, from the main transmitter to the receiving antenna of the retransmitter.

The retransmission technique of an embodiment of the invention also corrects all of the incident errors (BER=0) and reconstructs a MER that is just as, or even more, effective than that of a main transmitter (38 dB).

An embodiment of the invention also proposes such a signal retransmission technique that maintains the amount of DVB-T phase noise, unlike the “gap-fillers” of the prior art, which have the disadvantage of adding the phase noise of the main transmitter to their own phase noise. In other words, an embodiment of the invention is intended to provide such a technique that makes it possible to design repeaters providing better coverage at the same power.

In other words, while the conventional techniques for cancelling echo by adaptative filtering generate a residual echo, and are simply attenuate the coupling echoes from the transmitting antenna, an embodiment of the invention proposes such a retransmission technique that enables them to be entirely suppressed by providing performances consistent with the standards of the main transmitter in terms of MER and phase noise.

In particular, an embodiment of the invention provides such a retransmission technique that makes it possible to cancel the coupling echo effect due to the transmitting antenna, even though the level of this echo is close, and, in some cases, even greater than the level for receiving the signal to be transmitted.

An embodiment of the invention also provides such a retransmission technique that makes it possible to entirely eliminate the disturbances associated with the transmission channel in the incident signal, before retransmission thereof.

An embodiment of the invention provides a technique that is compatible with most new digital radio and/or television broadcasting standards, such as:
ATSC, for “Advanced Television System Committee”;
ISDBT, for “Integrated Services Digital Broadcasting Terrestrial”;
DAB, for “Digital Audio Broadcasting”;
T-DMB for “Terrestrial—Digital Media Broadcasting”;
DVB-T and DVB-H for “Digital Video Broadcasting Terrestrial” and “Digital Video Broadcasting Handheld”, etc.

In addition, an embodiment of the invention proposes such retransmission devices that can be set in an infinite cascade, which is not possible with the “gap-fillers” of the prior art, of which the imperfections limit, and even prevent cascading.

Although the present invention has been described with reference to preferred embodiments, workers skilled in the art will recognize that changes may be made in form and detail without departing from the spirit and scope of the invention.

What is claimed is:

1. A method for isofrequency retransmission of at least one digital signal, comprising:
receiving a source signal on a receiving antenna;
retransmitting said source signal by a transmitting antenna, a coupling occurring between said transmitting and receiving antennas, so that at least one coupling echo transmitted by said transmitting antenna is received with said source signal on said receiving antenna;
extracting said at least one coupling echo;
processing said coupling echo, so as to generate at least one correction signal;
subtracting said correction signal from said source signal, generating an improved signal; and
regenerating said improved signal by demodulation/remodulation, so as to retransmit said improved signal on said transmitting antenna.

2. The method for isofrequency retransmission according to claim 1, wherein extreacting said coupling echo implements a determination of at least one deformation parameter of said signal to be retransmitted on said transmitting antenna, due to said coupling.

3. The method for isofrequency retransmission according to claim 1, wherein said correction signal is obtained by adaptative deformation, taking into account said at least one deformation parameter, of said signal to be retransmitted on said transmitting antenna.

4. The method for isofrequency retransmission according to claim 2, wherein said deformation parameter belongs to the group including:
a gain;
a delay;
a phase; and
a group time.

5. The method for isofrequency retransmission according to claim 4, wherein said adaptative deformation of said signal to be retransmitted includes:
applying a fixed delay corresponding to a duration of a sub-step of processing said signal of said regeneration step, to said signal to be retransmitted, generating a delayed signal; and
adaptative filtering of said delayed signal, taking into account said gain and phase deformation parameters, so as to generate said correction signal.

6. The method for isofrequency retransmission according to claim 5, wherein said adaptative deformation of said signal to be retransmitted also introduces a variable delay in said signal, and said adaptative filtering implements a complex multiplication for correction of said gain and phase deformation parameters.

7. The method for isofrequency retransmission according to claim 1, wherein said extraction of said at least one coupling echo implements at least one digital algorithm belonging to the group including:
a correlation algorithm; and
an LMS-type error reduction algorithm.

8. The method for isofrequency retransmission according to claim 1 and further comprising amplifying said signal to be retransmitted.

9. A device for isofrequency retransmission of at least one digital signal, the device comprising:
means for receiving a source signal on a receiving antenna;
means for retransmitting said source signal by a transmitting antenna, a coupling occurring between said transmitting and receiving antennas, so that at least one coupling echo transmitted by said transmitting antenna is received with said source signal on said receiving antenna;
means for extracting at least one coupling echo from said source signal;
means for processing said at least one coupling echo, generating at least one correction signal;
means for subtracting said correction signal from said source signal, generating an improved signal; and
means for regenerating said improved signal by demodulation/remodulation, so as to retransmit said improved regenerated signal on said transmitting antenna.

10. A computer program product downloadable from a communications network and/or stored on a support, in machine-readable form and/or capable of being run by a microprocessor, comprising program code instructions for implementing an isofrequency retransmission method comprising:
receiving a source signal on a receiving antenna;
retransmitting said source signal by a transmitting antenna, a coupling occurring between said transmitting and receiving antennas, so that at least one coupling echo transmitted by said transmitting antenna is received with said source signal on said receiving antenna;
extracting said at least one coupling echo;
processing said coupling echo, so as to generate at least one correction signal;
subtracting said correction signal from said source signal, generating an improved signal; and
regenerating said improved signal by demodulation/remodulation, so as to retransmit said improved signal on said transmitting antenna.
